(19) United States
(12) Patent Application Publication
(10) Pub. No.: US 2025/0020421 A1
(43) Pub. Date: Jan. 16, 2025

(54) PHONON RAPID ADIABATIC PASSAGE

(71) Applicant: Quantinuum LLC, Broomfield, CO (US)

(72) Inventors: Robert Tyler SUTHERLAND, San Antonio, TX (US); William Cody BURTON, Northglenn, CO (US); Christopher GILBRETH, Erie, CO (US); Ivaylo MADJAROV, Broomfield, CO (US); Maya FABRIKANT, Broomfield, CO (US); Paul Levi LAURIA, Broomfield, CO (US)

(21) Appl. No.: 18/754,787

(22) Filed: Jun. 26, 2024

Related U.S. Application Data
(60) Provisional application No. 63/513,379, filed on Jul. 13, 2023.
(60) Provisional application No. 63/589,433, filed on Oct. 11, 2023.

(51) Int. Cl. F28F 13/00; G06F 1/20

(52) U.S. Cl. CPC F28F 13/00; G06F 1/20

(57) ABSTRACT

A method for laser cooling an object crystal comprising at least two atomic objects and confined by a confinement apparatus is provided. A controller controls one or more manipulation sources to cause a first instance of manipulation signals to be incident on the object crystal at a target location defined at least in part by the confinement apparatus. The manipulation signals are configured to laser cool a first motional mode of the object crystal. The controller causes an adiabatic transfer of phonons from a second motional mode of the object crystal to the first motional mode of the object crystal. The controller controls the one or more manipulation sources to cause a second instance of the manipulation signals to be incident on the object crystal at the target location. The manipulation signals are configured to laser cool the first motional mode of the object crystal.

### CROSS-REFERENCE TO RELATED APPLICATIONS

This application claims priority to U.S. Application No. 63/589,433, filed Oct. 11, 2023, and U.S. Application No. 63/513,379, filed Jul. 13, 2023, the contents of which are incorporated herein by reference in their entireties.

### TECHNICAL FIELD

Various embodiments relate to laser cooling of atomic objects confined by an atomic object confinement apparatus. For example, various embodiments relate to increasing a laser cooling rate of atomic objects through the use of phonon rapid adiabatic passage.

### BACKGROUND

In various scenarios, it is desirable to cool atomic objects trapped by an atomic object trap such that various operations may be performed on the atomic objects (e.g., experiments, controlled quantum evolution, and/or the like). However, in various scenarios, some motional modes of the atomic objects cool very slowly, and thus, the cooling steps of the atomic objects take up a significant fraction of the run time. It is challenging to cool all the motional modes of the atomic objects efficiently. Through applied effort, ingenuity, and innovation many deficiencies of such laser cooling systems have been solved by developing solutions that are structured in accordance with the embodiments of the present invention, many examples of which are described in detail herein.

### BRIEF SUMMARY OF EXAMPLE EMBODIMENTS

Example embodiments provide methods, systems, apparatuses, computer program products and/or the like for increasing a cooling rate through the use of phonon rapid adiabatic passage. For example, an object crystal comprising two or more atomic objects is confined by a confinement apparatus. At least one of the atomic objects of the object crystal is used as a sympathetic cooling atomic object. At least one of the atomic objects of the object crystal is used for storing quantum information, in an example embodiment. The object crystal has a plurality of motional modes. Some of the motional modes of the object crystal are easier and/or faster to cool than other motional modes. Motional energy may be transferred from harder and/or slower to cool motional modes to easier and/or faster to cool motional modes such that laser cooling of the object crystal can be performed on a shorter time scale.

According to one aspect, a method for cooling an object crystal comprising at least two atomic objects and confined by a confinement apparatus is provided. In an example embodiment, the method includes controlling one or more voltage sources to cause an object crystal length to decrease; and controlling the one or more voltage sources to cause the object crystal to experience a coupling force that increases to a maximum amplitude and then decreases from the maximum amplitude to a zero amplitude. The object crystal length is measured in a direction parallel to a radio frequency (RF) null axis defined by the confinement apparatus at the location of the object crystal. The coupling force has at least a component in a direction that is radial to the RF null axis. While the object crystal is experiencing a non-zero coupling force, the decrease in the object crystal length causes a first motional mode of the object crystal to be degenerate (in scenarios where the coupling force is the only relevant coupling of the two modes) with a second motional mode of the object crystal such that phonons are adiabatically transferred between the first motional mode and the second motional mode.

In an example embodiment, the method further includes, prior to controlling the one or more voltage sources to cause the object crystal length to decrease and the object crystal to experience the coupling force, controlling one or more manipulation sources to perform laser cooling of the first motional mode of the object crystal.

In an example embodiment, the method further includes controlling one or more manipulation sources to performing laser cooling of the first motional mode of the object crystal after the coupling force decreases to the zero amplitude.

In an example embodiment, the method further includes, after the coupling force decreases to the zero amplitude and prior to controlling the one or more manipulation sources to performing laser cooling of the first motional mode of the object crystal, controlling the one or more voltage sources to cause at least one of (a) the object crystal length to stop decreasing in size such that the object crystal length is maintained at a final length or (b) the object crystal length to increase to a length that is longer than the final length.

In an example embodiment, the one or more voltage sources and the one or more manipulation sources are controlled to iteratively perform (a) adiabatically transferring phonons between the first motional mode and the second motional mode and (b) laser cooling the first motional mode.

In an example embodiment, the phonons are adiabatically transferred between the first motional mode and the second motional mode by transferring one or more phonons from the second motional mode to an intermediate motional mode and transferring one or more phonons from the intermediate motional mode to the first motional mode.

In an example embodiment, the at least two atomic objects comprise a first atomic object of a first atomic object type and a second atomic object of a second atomic object type, where the first atomic object type is different from the second atomic object type.

In an example embodiment, the coupling force increases to the maximum amplitude over a first length of time, the coupling force decreases from the maximum amplitude to the zero amplitude over a second length of time, and the first length of time and the second length of time are longer than a reciprocal of the difference between the motional mode frequency of the first motional mode and the motional mode frequency of the second motional mode.

In an example embodiment, the coupling force is one of (a) a radial push, (b) a torque caused by a shim field in a plane parallel to a plane defined by the confinement apparatus, or (c) a higher order (third, fourth, etc.) derivative term in a potential generated by the confinement apparatus at the location of the object crystal.

According to another aspect, a system is provided. The system comprises a confinement apparatus configured to confine an object crystal comprising at least two atomic objects and defining, at least in part, a target location; one or more voltage sources operatively coupled to respective electrodes of the confinement apparatus; and a controller configured to control operation of the confinement apparatus and the one or more voltage sources. The controller is configured to control operation of the confinement apparatus and the one or more voltage sources to cause the system to perform at least confining the object crystal at the target location; causing voltage signals to be provided to the respective electrodes that cause an object crystal length of the object crystal to decrease; and causing a coupling signal to be provided to at least one of the respective electrodes to cause the object crystal to experience a coupling force that increases to a maximum amplitude and then decreases from the maximum amplitude to a zero amplitude. While the object crystal is experiencing a non-zero coupling force, the decrease in the object crystal length causes the first motional mode of the object crystal to be degenerate with the second motional mode of the object crystal such that phonons are adiabatically transferred between the first motional mode and the second motional mode.

In an example embodiment, the system is a quantum computer.

According to still another aspect, a controller is provided. The controller comprises at least one processor and a memory storing computer-executable instructions. The computer-executable instructions are configured to, when executed by the at least one processor, cause the controller to control operation of a confinement apparatus and one or more voltage sources to cause performance of confining the object crystal at the target location defined at least in part by the confinement apparatus; causing voltage signals to be provided to the respective electrodes that cause an object crystal length of the object crystal to decrease; and causing a coupling signal to be provided to at least one of the respective electrodes to cause the object crystal to experience a coupling force that increases to a maximum amplitude and then decreases from the maximum amplitude to a zero amplitude. While the object crystal is experiencing a non-zero coupling force, the decrease in the object crystal length causes the first motional mode of the object crystal to be degenerate with the second motional mode of the object crystal such that phonons are adiabatically transferred between the first motional mode and the second motional mode.

According to another aspect, a method for laser cooling an object crystal comprising at least two atomic objects and confined by a confinement apparatus. In an example embodiment, the method includes controlling one or more manipulation sources to cause a first instance of one or more manipulation signals to be incident on a target location defined at least in part by the confinement apparatus, the first instance of the one or more manipulation signals configured to laser cool a first motional mode of the object crystal, and the confinement apparatus operating to confine the object crystal at the target location; causing an adiabatic transfer of phonons from a second motional mode of the object crystal to the first motional mode of the object crystal; and controlling the one or more manipulation sources to cause a second instance of the one or more manipulation signals to be incident on the target location, the second instance of the one or more manipulation signals configured to laser cool the first motional mode of the object crystal.

In an example embodiment, the adiabatic transfer of phonons from the second motional mode to the first motional mode is performed via phonon rapid adiabatic passage.

In an example embodiment, performing the phonon rapid adiabatic passage comprises controlling one or more voltage sources to cause an object crystal length of the object crystal to decrease; and controlling the one or more voltage sources to cause the object crystal to experience a coupling force that increases to a maximum amplitude and then decreases from the maximum amplitude to a zero amplitude, wherein while the object crystal is experiencing a non-zero coupling force, the decrease in the object crystal length causes the first motional mode of the object crystal to be degenerate with the second motional mode of the object crystal such that phonons are adiabatically transferred between the first motional mode and the second motional mode.

In an example embodiment, the method further comprises, after the coupling force decreases to the zero amplitude and prior to controlling the one or more manipulation sources to cause the second instance of the one or more manipulation signals to be incident on the target location, controlling the one or more voltage sources to cause at least one of (a) the object crystal length to stop decreasing in size such that the object crystal length is maintained at a final length or (b) the object crystal length to increase to a length that is longer than the final length.

In an example embodiment, the one or more voltage sources and the one or more manipulation sources are controlled to iteratively perform (a) adiabatically transferring phonons between the first motional mode and the second motional mode and (b) laser cooling the first motional mode.

In an example embodiment, the coupling force increases to the maximum amplitude over a first length of time, the coupling force decreases from the maximum amplitude to the zero amplitude over a second length of time, and the first length of time and the second length of time are longer than a reciprocal of the difference between the motional mode frequency of the first motional mode and the motional mode frequency of the second motional mode.

In an example embodiment, the phonons are adiabatically transferred between the first motional mode and the second motional mode by transferring one or more phonons from the second motional mode to an intermediate motional mode and transferring one or more phonons from the intermediate motional mode to the first motional mode.

In an example embodiment, the at least two atomic objects comprise a first atomic object of a first atomic object type and a second atomic object of a second atomic object type, where the first atomic object type is different from the second atomic object type.

In an example embodiment, the adiabatic transfer of phonons takes less than 100 microseconds.

According to yet another aspect, a system is provided. In an example embodiment, the system includes a confinement apparatus configured to confine an object crystal comprising at least two atomic objects and defining, at least in part, a target location; one or more manipulation sources configured to generate and provide one or more manipulation sources; and a controller configured to control operation of the confinement apparatus and the one or more manipulation sources. The controller is configured to control operation of the confinement apparatus and the one or more manipulation sources to cause the system to perform at least causing the confinement apparatus to confine the object crystal at the target location; causing a first instance of the one or more manipulation signals to be incident on the target location, the first instance of the one or more manipulation signals configured to laser cool a first motional mode of the object crystal; causing an adiabatic transfer of phonons from a second motional mode of the object crystal to the first motional mode of the object crystal; and causing a second instance of the one or more manipulation signals to be incident on the target location, the second instance of the one or more manipulation signals configured to laser cool the first motional mode of the object crystal.

In an example embodiment, the system further includes one or more voltage sources operatively coupled to respective electrodes of the confinement apparatus, wherein the controller is configured to control operation of the one or more voltage sources to cause the system to perform at least voltage signals to be provided to the respective electrodes that cause an object crystal length of the object crystal to decrease; and a coupling signal to be provided to at least one of the respective electrodes to cause the object crystal to experience a coupling force that increases to a maximum amplitude and then decreases from the maximum amplitude to a zero amplitude, wherein while the object crystal is experiencing a non-zero coupling force, the decrease in the object crystal length causes the first motional mode of the object crystal to be degenerate with the second motional mode of the object crystal such that phonons are adiabatically transferred between the first motional mode and the second motional mode.

In an example embodiment, the system is a quantum computer, at least one of the at least two atomic objects of the object crystal is used as a qubit of the quantum computer, and at least another of the at least two atomic objects of the object crystal is used for sympathetically cooling the qubit.

According to yet another aspect, a controller is provided. The controller comprises at least one processor and a memory storing computer-executable instructions. The computer-executable instructions are configured to, when executed by the at least one processor, cause the controller to control operation of a confinement apparatus and one or more manipulation sources to cause performance of causing the confinement apparatus to confine the object crystal at the target location; causing a first instance of the one or more manipulation signals to be incident on the target location, the first instance of the one or more manipulation signals configured to laser cool a first motional mode of the object crystal; causing an adiabatic transfer of phonons from a second motional mode of the object crystal to the first motional mode of the object crystal; and causing a second instance of the one or more manipulation signals to be incident on the target location, the second instance of the one or more manipulation signals configured to laser cool the first motional mode of the object crystal.

In an example embodiment, the controller is further configured to control operation of one or more voltage sources operatively coupled to respective electrodes of the confinement apparatus, and the computer-executable instructions are further configured to, when executed by the at least one processor, cause the controller to control operation of the one or more voltage sources to cause performance of wherein the controller is configured to control operation of the one or more voltage sources to cause performance of at least causing voltage signals to be provided to the respective electrodes that cause an object crystal length of the object crystal to decrease; and causing a coupling signal to be provided to at least one of the respective electrodes to cause the object crystal to experience a coupling force that increases to a maximum amplitude and then decreases from the maximum amplitude to a zero amplitude, wherein while the object crystal is experiencing a non-zero coupling force, the decrease in the object crystal length causes the first motional mode of the object crystal to be degenerate with the second motional mode of the object crystal such that phonons are adiabatically transferred between the first motional mode and the second motional mode.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example atomic object quantum computer, in accordance with an example embodiment.

FIG. 2 provides a top view of a portion of an example atomic object confinement apparatus that may be used in example embodiment.

FIG. 3A provides schematic diagram of an object crystal confined by an example atomic object confinement apparatus, in accordance with an example embodiment.

FIG. 3B provides a schematic diagram of an object crystal confined by an example atomic object confinement apparatus and experiencing a coupling force, in accordance with an example embodiment.

FIG. 4 provides a plot illustrating the evolution of an object crystal length and a coupling force amplitude during performance of a phonon rapid adiabatic passage, in accordance with an example embodiment.

FIG. 5 provides a plot illustrating the effect of changing the object crystal length on the frequency of various motional modes of the object crystal, in accordance with an example embodiment.

FIG. 6 provides a schematic diagram of an example controller of a quantum computer comprising an atomic object confinement apparatus configured for confining atomic objects therein, in accordance with an example embodiment.

FIG. 7A provides a flowchart illustrating various processes and/or procedures performed by a controller to cause an atomic system and/or quantum computer to perform a cooling operation using of phonon rapid adiabatic passage, in accordance with an example embodiment.

FIG. 7B provides a flowchart illustrating various processes and/or procedures performed by a controller to cause an atomic system and/or quantum computer to perform a phonon rapid adiabatic passage on an object crystal, in accordance with an example embodiment.

FIG. 8 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, atomic objects are confined by an atomic object confinement apparatus (also referred to as a confinement apparatus herein). In various embodiments, the atomic objects are ions, ionic molecules, or multipolar molecules, and the atomic object confinement apparatus is an ion trap, such as a surface ion trap, Paul ion trap, and/or the like. In various embodiments, the atomic objects are neutral atoms or molecules and the atomic object confinement apparatus is an optical trap, magnetic trap, and/or the like.

In various embodiments, the atomic objects confined by the confinement apparatus include at least two atomic object types where atomic objects of different atomic object types have different masses, different atomic numbers, and/or different molecular compositions. Similarly, atomic objects of the same atomic object type have the same masses, atomic numbers, and/or molecular compositions. The atomic objects confined by the confinement apparatus may be organized and/or grouped into object crystals including at least a first atomic object of a first atomic object type (e.g., a first mass, atomic number, and/or molecular composition) and a second atomic object of a second atomic object type (e.g., a second mass, atomic number, and/or molecular composition), where there first mass, atomic number, and/or molecular composition is different from the second atomic object of a second mass, atomic number, and/or molecular composition.

In an example embodiment, the first atomic object is configured for use in sympathetic cooling of the second atomic object. For example, the second atomic object may be cooled to a desired temperature and/or motional state by laser cooling the first atomic object. In various embodiments, the quantum state of the second atomic object is used to store quantum information. For example, the quantum state of the second atomic object is manipulated to cause controlled evolution thereof (e.g., for us in atomic system experiments, quantum computing, and/or the like), in various embodiments. For example, the second atomic object is used as a qubit of a quantum computer, in an example embodiment.

The motional modes of the object crystal include axial motional modes that correspond to motion along an axis defined by the confinement apparatus and radial motional modes that correspond to motion in directions that are perpendicular to the axis defined by the confinement apparatus. Some motional modes of the object crystal are easier and/or faster to cool (e.g., have a faster cooling rate) than other motional modes. For example, radial motional modes that are dominated by motion of the second (e.g., quantum information storing) atomic object may be harder or slower to cool than axial motional modes or radial motional modes that are dominated by motion of the first (e.g., sympathetic cooling) atomic object.

In various embodiments, phonons (e.g., quanta of vibrational mechanical energy) are transferred from motional modes that are slower and/or harder to cool to motional modes that are faster and/or easier to cool using a rapid adiabatic passage process. For example, some motional modes of the object crystal have faster cooling rates (e.g., the motional energy in the faster to cool motional modes can be reduced more quickly than another motional mode of the object crystal. In another example some motional modes of the object crystal are technically easier to cool (e.g., using lasers of wavelengths that are technically easier generate or easier to guide from the laser source to the location of the object crystal). Various embodiments are configured to move motional energy from harder and/or slower to cool motional modes to easier and/or faster to cool motional modes of the object crystal to enable easier and/or faster cooling of the object crystal.

Each motional mode of the object crystal is associated with a respective frequency corresponds to the vibrational frequency of that motional mode. The frequency of motional modes of the object crystal is influenced by the confinement well frequency of the potential well of the confinement apparatus in which the respective object crystal is confined. By changing the confinement well frequency, which in various embodiments corresponds to the physical process of changing the object crystal length or the spacing/distance between the atomic objects of the object crystal, the frequencies of the motional modes may be changed. The respective frequencies of different motional modes of the object crystal have different functional dependencies on the confinement well frequency such that at particular confinement well frequencies degeneracies may be caused between different motional modes. By coupling the degenerate motional modes (e.g., using a coupling force), at least some of the phonons from the harder and/or slower to cool motional mode of the degenerate motional modes are transferred to the easier and/or faster to cool motional mode of the degenerate motional modes.

The laser cooling may then be performed to cool the easier and/or faster to cool motional mode such that the motional energy of the object crystal is reduced. The process of phonon rapid adiabatic transfer between one or more pairs of motional modes of the object crystal and then (laser) cooling the easier and/or faster to cool motional mode of the object crystal may be repeated as needed to cool the object crystal and/or reduce the motional energy of the object crystal to a level that is appropriate for the application.

In various embodiments, phonons from a harder and/or slower to cool motional mode(s) of the object crystal may be converted to the easier and/or faster to cool motional mode(s) of the object crystal through one or more intermediate motional modes of the object crystal. For example, in some scenarios, phonons (or motional energy) may be transferred directly from a harder and/or slower to cool motional mode of the object crystal to the easier and/or faster to cool motional mode of the object crystal via performance of phonon rapid adiabatic passage. In other scenarios, the phonons (or motional energy) may be transferred from the harder and/or slower to cool motional mode of the object crystal to the easier and/or faster to cool motion mode of the object crystal through multiple performances of phonon rapid adiabatic passage that couple different motional modes of the object crystal to provide the motional energy a path from the harder and/or slower to cool motional mode to the easier and/or faster to cool motional mode via one or more intermediate motional modes.

In various embodiments, the atomic objects confined by the atomic object confinement apparatus are used to perform experiments, controlled quantum state evolution, quantum computations, and/or the like. In various embodiments, in order for the atomic objects confined by the atomic object confinement apparatus to be used to perform the experiments, controlled quantum state evolution, quantum computations, and/or the like, the atomic objects need to be at a low temperature and/or cooled near the motional ground state for the atomic objects and/or object crystals that the atomic objects are part of. In various embodiments, laser cooling is used to reduce the motional energy of the atomic objects and/or object crystals.

Typical types of laser cooling include Doppler cooling, resolved sideband cooling, and EIT cooling. Doppler cooling includes cooling atomic objects via an optical transition that is broad compared to the object crystals motional transition. An atomic object's motional (secular) frequency is the frequency with which the atomic object oscillates in response to a confining potential and/or pseudopotential of the atomic object confinement apparatus, such as that generated by applying a radio frequency voltage signal to a radio frequency electrode and/or rail of a Paul surface ion trap, for example. EIT cooling includes applying two laser fields and a magnetic field to the atomic object. The laser fields are detuned from respective transitions of the sympathetic cooling atomic object of the object crystal. Cooling occurs when stronger photon absorption occurs on the red-detuned motional sidebands compared to the blue-detuned motional sidebands.

However, when cooling the object crystal, each motional mode of the object crystal has a different cooling rate (e.g., due to the motional modes each having a respective frequency corresponding thereto) and the cooling rates of different motional modes may be very different. The motions of an atomic object can be divided into several motional modes orthogonal to each other. For example, the motions of an object crystal or group consisting of N atomic objects may be described by 3*N uncoupled modes, whose dynamics may usually be treated independently. In various embodiments, the confinement apparatus defines linear confinement regions and the object crystal(s) confined thereby are linear object crystals. In other words, the atomic objects of the object crystal are disposed in a linear arrangement. Thus, the motional modes of the atomic object crystal may be divided into N axial modes primarily along a direction of a crystal axis (which is generally aligned with a confinement axis defined by the confinement region) and 2*N radial modes perpendicular to the direction of the crystal axis (and/or the confinement axis).

For example, the axial motional modes may cool much faster than the radial motional modes. However, the total cooling time can be limited by the slowest cooling rate of all the motional modes. This results in a significant amount of run time of various atomic systems and/or quantum computers being dedicated to cooling operations rather than quantum state evolution operations. Therefore, technical problems exist regarding laser cooling object crystals.

Various embodiments provide technical solutions to these technical problems. For example, various embodiments cause motional energy (e.g., phonons) to be adiabatically passed from one or more motional modes of the object crystal that are harder and/or slower to cool to one or more motional modes of the object crystal that are easier and/or faster to cool. For example, one or more performances of a phonon rapid adiabatic passage may be used to reduce the phonon population of one or more motional modes of the object crystal that are harder and/or slower to cool and correspondingly increase the phonon population of one or more motional modes of the object crystal that are easier and/or faster to cool. The one or more motional modes of the object crystal that are easier and/or faster to cool may then be efficiently cooled via laser cooling. The transfer of energy (phonons) from the harder and/or slower to cool motional modes of the object crystal to the easier and/or faster to cool motional modes of the object crystal enables cooling of atomic object crystal at a faster cooling rate than conventional laser cooling. As such, the effective cooling rate of the object crystal may be improved, and the object crystal may be cooled relatively efficiently.

### Exemplary Quantum Computer Comprising an Atomic Object Confinement Apparatus

Laser cooling of atomic objects and/or object crystals confined by an atomic object confinement apparatus may be performed in a wide variety of contexts and/or for a wide variety of applications. A phonon rapid adiabatic passage may be performed by a controller 30 configured to control operation of the confinement apparatus and/or a system comprising the confinement apparatus (e.g., a quantum computer) to increase the rate of the laser cooling of atomic objects and/or object crystals, in various embodiments.

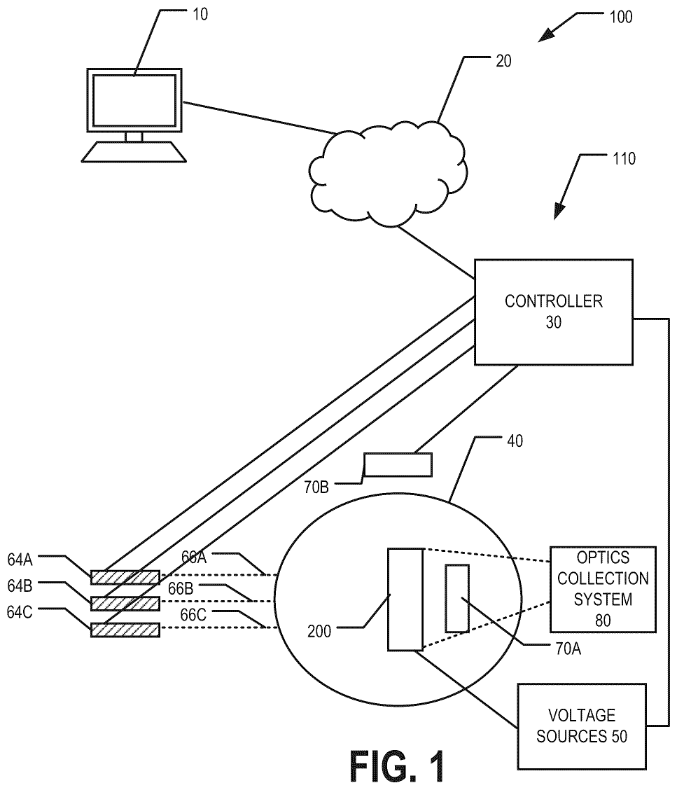

FIG. 1 provides a schematic diagram of an example quantum computer system 100 comprising a confinement apparatus 200 (e.g., an ion trap), in accordance with an example embodiment. In various embodiments, the quantum computer system 100 comprises a computing entity 10 and a quantum computer 110. In various embodiments, the quantum computer 110 comprises a controller 30, a cryostat and/or vacuum chamber 40 enclosing a confinement apparatus 200, one or more manipulation sources 64 (e.g., 64A, 64B, 64C), one or more voltage sources 50, one or more magnetic field generators 70 (e.g., 70A, 70B), an optics collection system 80, and/or the like. In various embodiments, the controller 30 is configured to control the operation of (e.g., control one or more drivers configured to cause operation of) the manipulation sources 64, voltage sources 50, magnetic field generators 70, a vacuum system and/or cryogenic cooling system (not shown), and/or the like. In various embodiments, the controller 30 is configured to receive signals (e.g., electrical signals) generated and provided by one or more photodetectors of the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more atomic objects confined by the confinement apparatus 200. For example, a first manipulation source 64A is configured to generate and/or provide a first manipulation signal and a second manipulation source 64B is configured to generate and/or provide a second manipulation signal, where the first and second manipulation signals are configured to collectively laser cool atomic objects and/or object crystals confined by the atomic object confinement apparatus 200.

In various embodiments, the atomic object confinement apparatus 200 is an ion trap, such as a surface ion trap, Paul ion trap, and/or the like. In various embodiments, the atomic objects are ions, atoms, molecules, and/or the like. In an example embodiment, an object crystal comprises two or more atomic objects having different masses, atomic numbers, and/or molecular compositions. In an example embodiment, an object crystal includes one or more a first atomic objects (e.g., atomic objects having a first atomic number) that are used as cooling atomic objects in a sympathetic cooling scheme for the object crystal. In an example embodiment, the object crystal includes one or more second atomic objects (e.g., atomic objects having a second atomic number) that are used as qubits of the quantum computer 110. For example, in an example embodiment, the object crystal is an ion crystal comprising a singly ionized Ba atom used as a cooling ion and a singly ionized Yb ion used as a qubit ion. In another example embodiment, the object crystal is an ion crystal comprising a singly ionized Yb atom used as a cooling ion and a singly ionized Ba ion used as a qubit ion. In an example embodiment, an object crystal includes one first atomic object and one second atomic object. In an example embodiment, an object crystal includes two first atomic objects and two second atomic objects. In various embodiments an object crystal may include various numbers and combinations of atomic objects.

In an example embodiment, the one or more manipulation sources 64 each provide a manipulation signal (e.g., laser beam and/or the like) to one or more regions and/or target locations of the atomic object confinement apparatus 200 via corresponding beam paths 66 (e.g., 66A, 66B, 66C). In various embodiments, at least one beam path 66 comprises a modulator configured to modulate the manipulation signal being provided to the confinement apparatus 200 via the beam path 66. In various embodiments, the manipulation sources 64, active components of the beam paths (e.g., modulators, etc.), and/or other components of the quantum computer 110 are controlled by the controller 30.

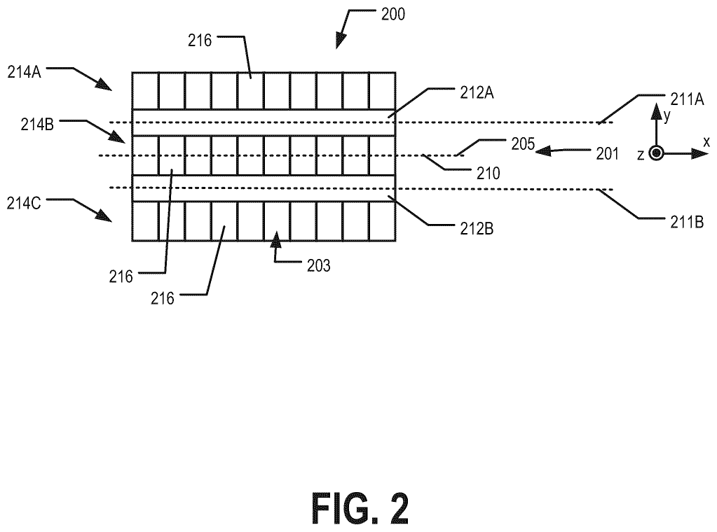

In various embodiments, the quantum computer 110 comprises one or more voltage sources 50. For example, the voltage sources may be arbitrary wave generators (AWG), digital analog converters (DACs), and/or other voltage signal generators. For example, the voltage sources 50 may comprise a plurality of control voltage drivers and/or voltage sources and/or at least one RF driver and/or voltage source. The voltage sources 50 may be electrically coupled to the corresponding potential generating elements (e.g., control electrodes 216 and/or RF electrodes 212, as shown in FIG. 2) of the confinement apparatus 200, in an example embodiment.

In various embodiments, the quantum computer 110 comprises one or more magnetic field generators 70 (e.g., 70A, 70B). For example, the magnetic field generator may be an internal magnetic field generator 70A disposed within the cryogenic and/or vacuum chamber 40 and/or an external magnetic field generator 70B disposed outside of the cryogenic and/or vacuum chamber 40. In various embodiments, the magnetic field generators 70 comprise permanent magnets, Helmholtz coils, electrical magnets, and/or the like. In various embodiments, the magnetic field generators 70 are configured to generate a magnetic field at one or more regions and/or target locations of the atomic object confinement apparatus 200 that has a particular magnitude and a particular magnetic field direction in the one or more regions and/or target locations of the atomic object confinement apparatus 200.

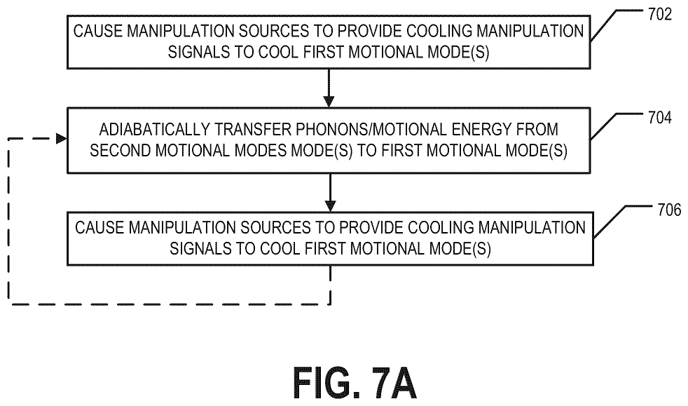

In various embodiments, the quantum computer 110 comprises an optics collection system 80 configured to collect and/or detect photons (e.g., stimulated emission) generated by qubits (e.g., during reading procedures). The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits (e.g., atomic objects) of the quantum computer 110. In various embodiments, the detectors may be in electronic communication with the quantum computer controller 30 via one or more A/D converters 625 (see FIG. 6) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control operation of the voltage sources 50, magnetic field generators 70, cryogenic system and/or vacuum system controlling the temperature and pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more atomic objects within the confinement apparatus, and/or read and/or detect a quantum (e.g., qubit) state of one or more atomic objects within the confinement apparatus. For example, the controller 30 may cause a controlled evolution of quantum states of one or more atomic objects within the confinement apparatus to execute a quantum circuit and/or algorithm. For example, the controller 30 may read and/or detect quantum states of one or more atomic objects within the confinement apparatus at one or more points during the execution of a quantum circuit. In various embodiments, the atomic objects confined by the confinement apparatus are used as qubits of the quantum computer 110.

### Exemplary Atomic Object Confinement Apparatus

FIG. 2 provides a top view of at least a portion of an example confinement apparatus 200 that may be used to confine at least two atomic objects. For example, in an example embodiment, the confinement apparatus is an ion trap (e.g., a surface ion trap) and the atomic objects are ions. In an example embodiment, the confinement apparatus 200 (e.g., surface ion trap) is fabricated as part of an ion trap chip and/or part of an ion trap apparatus and/or package. In an example embodiment, the confinement apparatus 200 is at least partially defined by a number of RF electrodes 212 (e.g., 212A, 212B). In various embodiments, the confinement apparatus 200 is at least partially defined by a number of sequences of control electrodes 214 (e.g., 214A, 214B, 214C). Each sequence of control electrodes 214 comprises a plurality of control electrodes 216. In an example embodiment, each control electrode 216 and/or at least a non-empty subset of the control electrodes 216 may be operated independently via the application of control signals thereto. In an example embodiment, the confinement apparatus 200 is a surface Paul trap with symmetric RF electrodes 212. In various embodiments, the RF electrodes 212 and the control electrodes 216 generate potentials and/or fields that are experienced by atomic objects within a confinement region 201 of the confinement apparatus 200. In particular, the RF electrodes 212 may be configured to define the confinement region 201 of the confinement apparatus 200 and the control electrodes 216 may be configured to at least partially control movement and/or motion of atomic objects within the confinement region 201.

In various embodiments, the upper surface of the confinement apparatus 200 has a planarized topology. For example, the upper surface of each RF electrode 212 of the number of RF electrodes 212 and the upper surface of each control electrode 216 of the number of sequences of control electrodes 214 may be substantially coplanar.

In various embodiments, the confinement apparatus 200 comprises and/or is at least partially defined by a number of RF electrodes 212. The RF electrodes 212 are formed with substantially parallel longitudinal axes 211 (e.g., 211A, 211B) and with substantially coplanar upper surfaces. For example, the RF electrodes 212 are substantially parallel such that a distance between the RF electrodes 212 is approximately constant along the length of the RF electrodes 212 (e.g., the length of an RF electrode being along the longitudinal axes 211 of RF electrode 212). For example, the upper surfaces of the RF electrodes 212 may be substantially flush with the upper surface of the confinement apparatus 200.

In an example embodiment, the number of RF electrodes 212 comprises two RF electrodes 212 (e.g., 212A, 212B). In various embodiments, the confinement apparatus 200 may comprise a plurality of number of RF electrodes 212. For example, the confinement apparatus 200 may be a two-dimensional ion trap that comprises multiple numbers (e.g., pairs and/or sets) of RF electrodes 212 with each number (e.g., pair and/or set) of RF electrodes 212 having substantially parallel longitudinal axes 211. In an example embodiment, a first number of RF electrodes 212 have mutually substantially parallel longitudinal axes 211, a second number of RF electrodes 212 have mutually substantially parallel longitudinal axes 211, and the longitudinal axes of the first number of RF electrodes and the longitudinal axes of the second number of RF electrodes are substantially non-parallel (e.g., transverse). FIG. 2 illustrates an example one dimensional confinement apparatus 200 and/or a portion of a two-dimensional confinement apparatus 200 having two RF electrodes 212, though other embodiments may comprise additional RF electrodes in various configurations.

In various embodiments, two adjacent RF electrodes 212 may be separated (e.g., insulated) from one another by a longitudinal gap. In various embodiments, the confinement region 201 is at least partially over the longitudinal gap. For example, the longitudinal gap may define (in one or two dimensions) the confinement region 201. In various embodiments, the confinement region 201 may extend substantially parallel to the longitudinal axes 211 of the adjacent RF electrodes 212. For example, the longitudinal gap may extend substantially parallel to the x-axis as shown in FIG. 2. In an example embodiment, the longitudinal gap may be at least partially filled with an insulating material (e.g., a dielectric material). In various embodiments, the dielectric material may be silicon dioxide (e.g., formed through thermal oxidation) and/or other dielectric and/or insulating material. In various embodiments, the longitudinal gap has a height (e.g., in the y-direction) of approximately 40 μm to 500 μm. In various embodiments, one or more sequences of control electrodes 214 (e.g., a second sequence of control electrodes 214B) may be disposed and/or formed within the longitudinal gap.

In an example embodiment, a transverse gap may exist between neighboring and/or adjacent control electrodes 216 of the one or more sequences of control electrodes 214. In an example embodiment, the transverse gap may be empty space and/or at least partially filled with a dielectric material to prevent electrical communication between neighboring and/or adjacent electrodes. In an example embodiment, the transverse gap between neighboring and/or adjacent electrodes may be in the range of approximately 1-10 μm.

In an example embodiment, a longitudinal gap exists between a sequence of control electrodes 214 and a neighboring and/or adjacent RF electrode 212. In an example embodiment, the longitudinal gap may be at least partially filled with a dielectric and/or insulating material to prevent electrical communication between control electrodes 216 of the sequence of control electrodes 214 and the RF electrode 212. In an example embodiment, the longitudinal gap between neighboring and/or adjacent electrodes may be in the range of approximately 1-10 μm.

In various embodiments, the confinement apparatus 200 may be at least partially defined by a number of sequences of control electrodes 214 (e.g., first sequence of control electrodes 214A, second sequence of control electrodes 214B, third sequence of control electrodes 214C). Each sequence of control electrodes 214 is formed to extend substantially parallel to the substantially parallel longitudinal axes 211 of the RF electrodes 212. For example, the number of sequences of control electrodes 214 may extend substantially parallel to the x-axis as shown in FIG. 2. In various embodiments, the number of sequences of control electrodes 214 comprises two, three, four, and/or another number of sequences of control electrodes 214. In an example embodiment, the confinement apparatus 200 comprises a plurality of number of sequences of control electrodes 214. For example, the illustrated confinement apparatus 200 is a one-dimensional ion trap comprising three sequences of control electrodes 214. For example, the confinement apparatus 200 may be a two-dimensional ion trap that comprises multiple numbers of sequences of control electrodes 214 that each extend substantially parallel to a substantially parallel longitudinal axes of a corresponding number of RF electrodes 212. In an example embodiment, a first number of sequences of control electrodes 214 extend substantially parallel to the substantially parallel longitudinal axes 211 of a first number of RF electrodes 212, a second number of sequences of control electrodes 214 extend substantially parallel to the substantially parallel longitudinal axes 211 of a second number of RF electrodes 212, and the longitudinal axes of the first number of RF electrodes and the longitudinal axes of the second number of RF electrodes are substantially non-parallel (e.g., transverse). In some embodiments, each of the control electrodes 216 of the number of sequences of control electrodes 214 can be formed with substantially coplanar upper surfaces that are substantially coplanar with the upper surfaces of the RF electrodes 212.

In an example embodiment (e.g., as illustrated in FIG. 2), a number (e.g., pair) of RF electrodes 212 may be formed between a first sequence of control electrodes 214A and a third sequence of control electrodes 214C with a second sequence of control electrodes 214B extending along the longitudinal gap between the RF electrodes 212. For example, each sequence of control electrodes 214 may extend in a direction substantially parallel to the longitudinal axes 211 of the RF electrodes 212 (e.g., in the x-direction). In various embodiments, the upper surfaces of the sequences of control electrodes 214 are substantially coplanar with the upper surfaces of the RF electrodes 212.

In various embodiments, RF signals may be applied to the RF electrodes 212 to generate an electric and/or magnetic field that acts to maintain one or more atomic objects (e.g., ion(s)) trapped within the confinement apparatus 200 in directions transverse to the longitudinal direction of the confinement apparatus 200 (e.g., the y- and z-directions). In various embodiments, control signals and/or voltages are applied to the control electrodes 216 to generate a desired electric potential field within the confinement region 201. For example, in various embodiments, time-dependent, time-varying, time evolving, and/or non-static direct current (DC) voltages may be applied to the control electrodes 216 to generate a time-dependent, time-varying, time evolving, and/or non-static electric potential field that causes the atomic objects trapped within the confinement apparatus 200 to traverse corresponding trajectories to within the confinement region 201. For example, the atomic objects may be moved between various zones, regions, and/or target locations of the confinement apparatus 200 such that various functions may be performed thereon. For example, the atomic objects may be initialized, gated via single qubit gates, gated via double/multiple qubit gates, transported and/or stored, read and/or detected, and/or the like.

In various embodiments, transportation and/or performance of other functions on the atomic objects may provide heat or motional energy to the atomic objects. Thus, in various embodiments, it may be desired to cool the atomic objects (e.g., and/or object crystals that include the atomic objects).

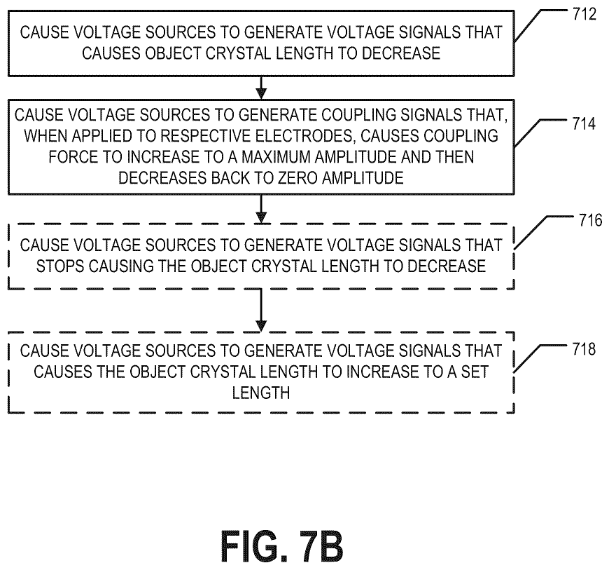

In various embodiments, the control signals and/or voltages applied to the control electrodes 216 are generated by one or more voltage sources 50. For example, a control electrode 216 may be in electric communication with a respective voltage source 50 via one or more of leads, wires, traces, vias, and/or the like. The operation of the one or more voltage sources 50 is controlled by one or more connected devices (e.g., a controller 30 as shown in FIG. 7 and/or the like). For example, depending on the electric monopole and/or dipole (or higher magnitude pole) strength (e.g., electric charge in the case of an electric monopole) of the atomic object, the amplitude of control signals (e.g., voltages) applied to the control electrodes 216 may be increased or decreased in the vicinity of a particular atomic object to cause the particular atomic object to traverse a desired trajectory. For example, a controller 30 may control a voltage driver of the voltage sources 50 to cause the voltage driver to apply control signals and/or voltages to the control electrodes 216 to generate a time-dependent electric potential (e.g., an electric potential that evolves, changes, and/or varies with time) that causes the atomic objects within the confinement apparatus 200 to traverse desired trajectories.

Depending on such factors as the electric monopole and/or dipole (or higher magnitude pole) strength (e.g., electric charge in the case of an electric monopole) of the atomic objects and/or the shape and/or magnitude of the combined electrical and/or magnetic fields, the atomic objects can be stabilized at a particular distance (e.g., approximately 20 μm to approximately 200 μm) above an upper surface of the confinement apparatus 200 (e.g., the coplanar upper surface of the sequences of control electrodes 214 and RF electrodes 212). To further contribute to controlling the transit of atomic objects along desired trajectories, the confinement apparatus 200 may be operated within a cryogenic and/or vacuum chamber capable of cooling the confinement apparatus 200 to a temperature of less than 124 Kelvin (e.g., less than 100 Kelvin, less than 50 Kelvin, less than 10 Kelvin, less than 5 Kelvin, and/or the like), in various embodiments.

In various embodiments, the RF electrodes 212, the sequences of control electrodes 214, and/or the confinement potential generated by the RF electrodes and/or the sequences of control electrodes 214 define a confinement region 201 of the confinement apparatus 200. In an example embodiment, the RF electrodes 212 and/or the confinement potential generated by the RF electrodes define a confinement region 201 of the confinement apparatus 200 and the control electrodes 216 control the movement and/or positioning of the atomic objects within the confinement region 201. In various embodiments, the RF electrodes 212, the sequences of control electrodes 214, and/or the confinement potential generated by the RF electrodes and/or the sequences of control electrodes 214 define a longitudinal axis 205 of the confinement apparatus 200. For example, the RF electrodes 212 and/or the confinement potential generated by the RF electrodes may define a longitudinal axis 205 of the confinement apparatus 200. In various embodiments, the confinement potential generally acts to align the atomic objects within the confinement apparatus 200 along the RF null axis 210 and/or the longitudinal axis 205 of the confinement apparatus 200.

As noted above, various other embodiments may use various other types of confinement apparatuses, such as optical traps, magnetic traps, other types of ion traps, and/or the like, as appropriate for the application and the atomic objects.

### Example Cooling Operations

Various embodiments provide quantum computers, systems, apparatuses, and/or the like and corresponding methods for performing laser cooling atomic objects. In various embodiments a first atomic object of an object crystal is used to sympathetically cool a second atomic object of the object crystal. In various embodiments, the transference of phonons and/or motional energy to one or more first motional modes of the object crystal from one or more second modes of the object crystal is used to decrease laser cooling time of the object crystal and/or decrease the technical difficulty of laser cooling the atomic object using one or more types of laser cooling (e.g., Doppler cooling, resolved sideband cooling, EIT cooling, and/or the like). In various embodiments, the one or more first motional modes of the object crystal are easier and/or faster to cool compared to the one or more second motional modes of the object crystal.

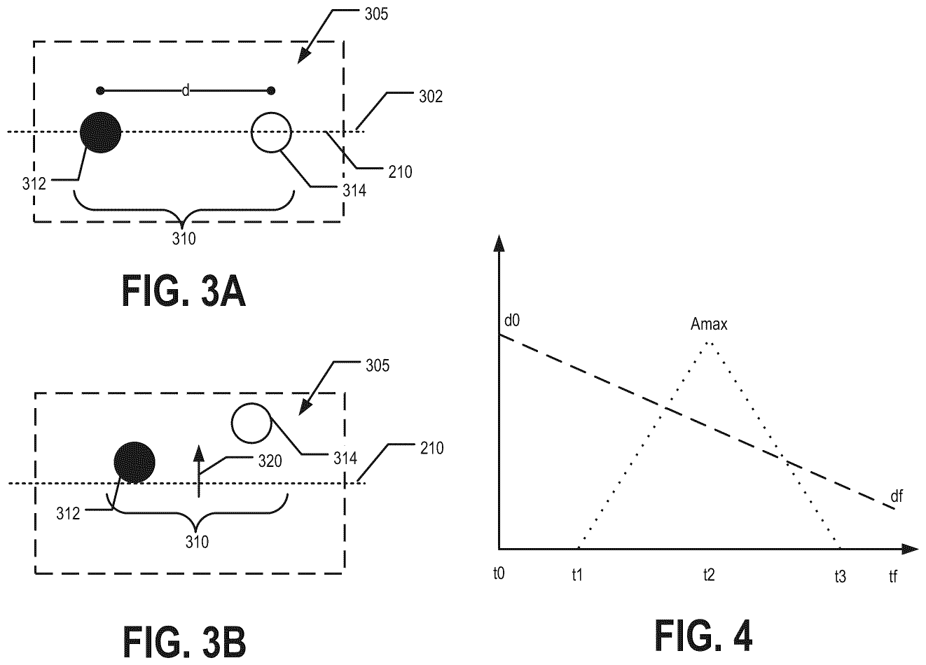

For example, FIG. 3A illustrates an object crystal 310 comprising a first atomic object 312 and a second atomic object 314 located at a target location 305. The target location 305 is defined, at least in part, by the confinement apparatus 200. The first atomic object 312 and second atomic object 314 are aligned along object axis 302. In various embodiments, the object axis 302 is parallel and/or co-linear with the RF null axis 210 and/or the longitudinal axis 205 of the confinement apparatus 200 at the target location 305. The physical extent or length of the object crystal 310 is the object crystal length d. As should be understood, the object crystal, in various embodiments, may include more than two atomic objects and may include atomic objects of more than two atomic object types (e.g., atomic objects of different atomic masses, atomic numbers, and/or molecular compositions).

The illustrated object crystal 310 has six different motional modes. For example, the motional modes of the object crystal 310 include two axial motional modes that in the direction of the object axis 302, two radial motional modes that are perpendicular to the object axis 302 and that are in the plane of the page, and two radial motional modes that are perpendicular to the object axis 302 and that are perpendicular to the plane of the page, in an example embodiment. One or more of these motional modes (e.g., the two axial modes, in an example embodiment) may be easier and/or faster to cool than one or more other motional modes (e.g., the radial modes, in an example embodiment).

In an example embodiment, laser cooling is used to cool one or more first motional modes of the object crystal. This results in the phonon population of the one or more first motional modes being very low and/or possibly zero. However, the phonon populations of one or more second motional modes of the object crystal are substantially unaffected by the cooling of the one or more first motional modes of the object crystal. To decrease the phonon population of a second motional mode, a first portion of the phonon population of the second motional mode is transferred to a motional mode having a smaller phonon population (e.g., one of the first motional modes). This phonon population transfer is performed using a phonon rapid adiabatic passage. In an example embodiment, nearly all of the phonon population of the second motional mode is transferred to the first motional mode via a performance of a phonon rapid adiabatic passage and vice versa (e.g., nearly all of the phonon population of the first motional modes is transferred to the second motional mode via the performance of the phonon rapid adiabatic passage). In another example embodiment, a fraction less than one (e.g., 0.9, 0.8, 0.75, 0.7, 0.6, 0.5, 0.4, 0.3, 0.25, and/or the like) of the phonon population of the second motional mode is transferred to the first motional mode via a performance of a phonon rapid adiabatic passage. The first motional mode that received at least a portion of the phonon population from the second motional mode may be cooled again (e.g., using a laser cooling technique) such that the phonon population of the first motional mode is again decreased to close to or equal to zero. Another phonon rapid adiabatic passage may be performed to transfer a second portion of the phonon population of the second motional mode to the first motional mode, which may then be depleted again using a laser cooling technique. Iteratively reducing the respective phonon populations of the one or more second motional modes via phonon rapid adiabatic passage and depleting the phonon populations of the one or more first motional modes may be performed until the object crystal is sufficiently cooled for the application. For example, cooling of the one or more first motional modes via laser cooling and cooling of the one or more second motional modes via phonon rapid adiabatic passage may be repeated and/or iterated until a desired level of cooling is achieved.

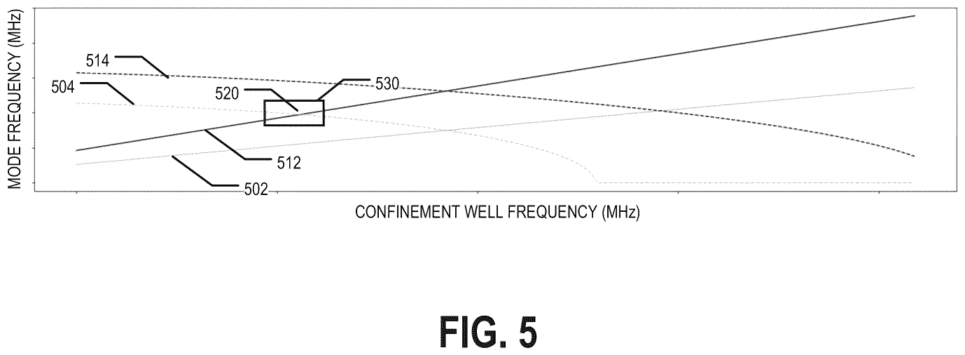

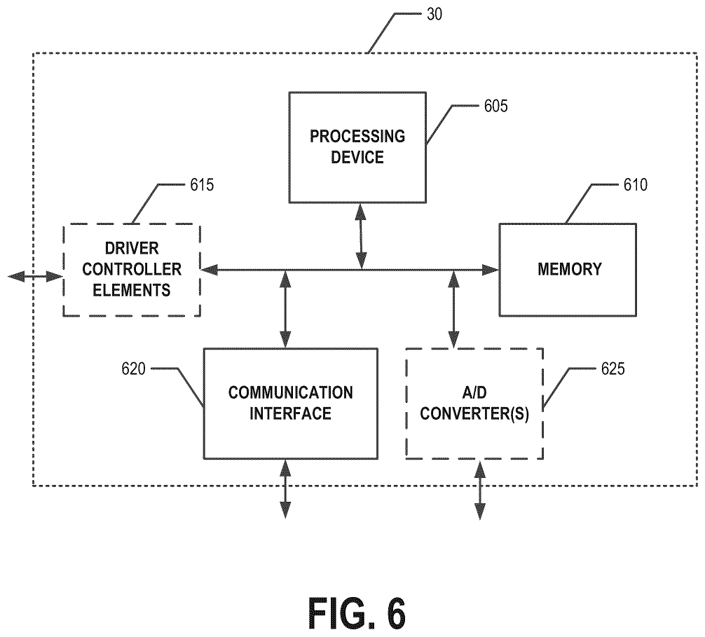

FIGS. 4 and 5 illustrate various components of how a phonon rapid adiabatic passage is performed between a set of motional modes of an object crystal. FIG. 5 provides a plot illustrating the mode frequencies of four different motional modes of an object crystal evolve as the confinement well frequency changes. As should be understood, the object crystal is confined within a confinement well (e.g., a potential well) generated by the confinement apparatus 200. For example, the application of appropriate voltage signals to the RF electrodes 212 and the control electrodes 216 of the confinement apparatus 200 causes the electric potential well that acts as a confinement well and confines the object crystal. The physical width of the confinement well (in the direction of the longitudinal axis 205) corresponds to and/or control the object crystal length d. The physical width of the confinement well (in the direction of the longitudinal axis 205) corresponds to the confinement well frequency. For example, as the confinement well frequency is increased, the object crystal length d decreases. For example, voltage signals provided to the control electrodes 216 cause the curvature of the (electric) potential well within which the object crystal is confined may be increased in the direction of the longitudinal axis 205. This causes the object crystal length d to decrease and the frequency (e.g., a harmonic oscillator frequency) corresponding to the potential well in the direction of the longitudinal axis 205 to increase.

Solid line 502 illustrates the evolution of an axial motional mode of the object crystal that is dominated by motion of a first atomic object of the object crystal as the confinement well frequency increases. Solid line 512 illustrates the evolution an axial motional mode of the object crystal that is dominated by motion of a second atomic object of the object crystal as the confinement well frequency increases. Dashed line 504 illustrates a radial motional mode that is dominated by motion of the first atomic object and dashed line 514 illustrates another radial motional mode that is dominated by motion of the second atomic object of the object crystal as the confinement well frequency increases.

Degeneracy point 520 is formed by the intersection of dashed line 504 (the mode frequency of a radial motional mode that is dominated by motion of the first atomic object of the object crystal) and solid line 512 (the mode frequency of an axial motional mode that is dominated by motion of the second atomic object of the object crystal). Thus, when the confinement well frequency is equal to the value corresponding to degeneracy point 520, the motional modes of the object crystal corresponding to lines 504 and 512 are degenerate (e.g., have the same mode frequency).

While the confinement well frequency is close to the confinement well frequency corresponding to the point of degeneracy between the motional modes of the object crystal corresponding to lines 504 and 512 (e.g., within approximately 100 kHz of the confinement well frequency corresponding to degeneracy point 520), the atomic objects of the object crystal are coupled via interaction of the atomic objects with a coupling force. For example, one or more coupling signals may be applied to respective control electrodes 216 in or near the target location 305 to cause the atomic objects 312, 314 of the object crystal 310 to experience the coupling force.

FIG. 3B illustrates an example result of the object crystal 310 experiencing the coupling force 320. In an example embodiment, the coupling force 320 is a radial push in a direction that is perpendicular to the RF null axis 210. In an example embodiment, the radial push of the coupling force has a different amplitude at the location of the first atomic object 312 compared to at the location of the second atomic object 314. In an example embodiment, the radial push of the coupling force has the same amplitude at the location of the first atomic object 312 and the location of the second atomic object 314. For example, one or more coupling signals may be generated and applied to respective electrodes (e.g., control electrodes 216) to cause a radial electric field to be generated that causes the atomic objects 312, 314 to experience the radial push.

In an example embodiment, the coupling force is a torque caused by a shim field in a plane that is parallel to a plane defined by a surface of the atomic object confinement apparatus 200 (e.g., the xy plane as illustrated in FIG. 2). For example, one or more coupling signals may be generated and applied to respective electrodes (e.g., control electrodes 216) to cause a (electric) shim field to be generated that causes the atomic objects 312, 314 to experience the shim field.

In an example embodiment, the coupling force is a higher order (third, fourth, etc.) derivative term in a potential generated by the confinement apparatus at the location of the object crystal. As used herein, a higher order derivative term refers to a derivative term that is third order or higher. For example, voltage sources 50 generate and provide voltage signals that are applied to control electrodes 216 of the confinement apparatus 200. The application of the voltage signals to the control electrodes 216 causes a potential (e.g., an electric potential) to be generated. The potential generated at the location of the object crystal may be configured (e.g., via the applied voltage signals) to include higher order derivatives (e.g., third, fourth, etc. order derivatives) that, when the object crystal experiences the potential, causes the object crystal to experience the coupling force.

In various embodiments, the first atomic object 312 is heavier and/or more massive than the second atomic object 314. As a result, the second atomic object 314 moves a further distance from the RF null axis 210 than the first atomic object 312. As the coulomb force between the first atomic object 312 and the second atomic object 314 has components in both the axial direction (e.g., parallel to the RF null axis 210) and components in a radial direction (e.g., perpendicular to the RF null axis 210) as a result of the object crystal 310 experiencing the coupling force 320, the coulomb force between the first atomic object 312 and the second atomic object 314 couples the axial and radial motional modes of the atomic objects 312, 314 and/or of the object crystal 310 such that phonons can be transferred between the radial and axial motional modes at the point of degeneracy.

As a result of the object crystal 310 experiencing the coupling force, the phonon populations of the motional modes of the object crystal corresponding to lines 504 and 512 become equalized. For example, as the object crystal length d continues to decrease and the confinement well frequency continues to increase, the motional modes of the object crystal corresponding to lines 504 and 512 are no longer degenerate. However, the mixing of the phonon populations of the two motional modes at the point of degeneracy results in some of the phonons that were previously in the motional mode corresponding to the line 504 are now populating the motional mode corresponding to the line 512, and vice versa. If the motional mode corresponding to line 512 initially had a very small phonon population (e.g., approximately zero) and the motional mode corresponding to line 504 had a positive phonon population, the result of the coupling force being applied at the point degeneracy (e.g., degeneracy point 520) results in the phonon population of the motional mode corresponding to line 512 being increased and the phonon population of the motional mode corresponding to line 504 to be decreased. Thus, if the motional mode corresponding to line 512 is easier and/or faster to cool than the motional mode corresponding to line 504, the transfer of phonon population between the two motional modes enables easier and/or faster cooling of the object crystal.

In various embodiments, the transfer of phonons between motional mode of the object crystal is performed adiabatically. For example, at least one of the atomic objects of the object crystal may be used to store quantum information. For example, the evolution of the quantum state of the second atomic object may be controlled (e.g., as part of performing a quantum circuit and/or the like). To maintain and/or not destroy the quantum information stored by at least one atomic object of the object crystal, the transferring of the phonons between motional modes of the object crystal is performed coherently. The adiabatic transferring of the phonons between the motional modes of the object crystals ensures that the transferring of the phonons between motional modes of the object crystal is performed coherently.

As should be understood by one of skill in the art, an adiabatic transfer of phonons is a transferring of phonons (e.g., via coupling of the respective motional modes of the object crystal) that occurs slowly enough to prevent the object crystal undergoing the motional mode coupling or phonon transfer to transition to other eigenstates. For example, the coupling and/or phonon transition occurs slowly relative to the mode frequency(ies) of the motional modes being coupled and/or between which the phonons are being transferred.

To cause the transferring of phonons between motional modes of the object crystal to be performed adiabatically, the coupling force is turned on slowly and then, after the transference of the phonons, turned off slowly. For example, the amplitude of the coupling force is zero at the beginning of the performance of the phonon rapid adiabatic passage. The amplitude of the coupling force is slowly (with respect to the motional mode frequency(ies) of the motional modes being coupled) increased to a maximum amplitude. The amplitude of the coupling force is then slowly (with respect to the motional mode frequency(ies) of the motional modes being coupled) decreased from the maximum amplitude back to zero. The coupling force reaches the maximum amplitude at approximately the same time (e.g., within 1-10 microseconds of) the confinement well frequency evolving such that the motional modes being coupled pass through the degeneracy point (e.g., where the respective mode frequencies of the motional modes being coupled via the phonon rapid adiabatic passage are equivalent).

FIG. 4 illustrates evolution of the object crystal length d (the dashed line) and the evolution of the amplitude of the coupling force (the dotted line) from an initial time t₀ when performance of a phonon rapid adiabatic passage is initiated to a final time t_{f} when performance of the phonon rapid adiabatic passage is completed. Starting at the initial time t₀, the object crystal length d is equal to an initial length d₀. At the final time t_{f}, the object length d is equal to a final length d_{f}. In an example embodiment, the initial length d₀ is 4 microns and the final length d_{f} is 3 microns. In various embodiments, various other initial lengths d₀ and/or final lengths d_{f} may be used as appropriate for application. In various embodiments, the object crystal length d decreases monotonically between the initial time t₀ and the final time t_{f}. In the illustrated embodiment, the object crystal length d decreases linearly between the initial time t₀ and the final time t_{f}. In various embodiments, the object crystal length d decreases between the initial time t₀ and the final time t_{f} monotonically in various forms (e.g., quadratically, cubically, exponentially, etc.).

At a first time t₁, which is after and/or at the same time as the initial time t₀ (when the evolution of the object crystal length d was initiated, started, and/or begun), the amplitude of the coupling force is increased from zero amplitude. At a second time t₂, which is after the first time t₁, the coupling force reaches a maximum amplitude Aₘₐₓ. After reaching the second time t₂, the amplitude of the coupling force is decreased until the amplitude of the coupling force reaches zero at a third time t₃, which is after the second time t₂. The final time t_{f} (when the evolution of the object crystal length d was stopped, ended, and/or completed) is after and/or at the same time as the third time t₃. In various embodiments, the temporal length of the performance of the phonon rapid adiabatic passage (e.g., t_{f}−t₀) is five to thirty microseconds. In various embodiments, the temporal length of the performance of the phonon rapid adiabatic passage (e.g., t_{f}−t₀) is ten to twenty microseconds.

In an example embodiment, the coupling force is generated by applying a (non-oscillating) coupling signal (e.g., a voltage signal generated by a voltage source 50) to one or more control electrodes 216. Causing the amplitude of the coupling force to increase is accomplished by increasing the voltage amplitude of the coupling signal (e.g., for zero to a maximum voltage) and causing the amplitude of the coupling force to decrease is accomplished by decreasing the voltage amplitude of the coupling signal (e.g., from the maximum voltage to zero), in an example embodiment. In various embodiments, the (absolute) maximum voltage is in a range of one to twenty volts.

In an example embodiment, the transition window 530 about the degeneracy point 520 has a width of 500-50 kHz in mode frequency. In an example embodiment, the transition window 530 corresponds to the time between the first time t₁ and the third time t₃. For example, when performing a phonon rapid adiabatic passage, the object crystal reaches the left side of the transition window 530 at the first time t₁. In other words, in various embodiments, the coupling force begins being increased from zero amplitude toward the maximum amplitude when the mode frequencies of the motional modes being coupled are within 200 to 50 kHz of one another (e.g., 100-50 kHz of one another). The coupling force returns to zero amplitude as the object crystal reaches the right side of the transition window 530 at the third time t₃. In other words, in various embodiments, the coupling force returns to zero amplitude when the mode frequencies of the motional modes that were coupled are within 200 to 50 kHz of one another (e.g., 100-50 kHz of one another).

### Example Controller

In various embodiments, a confinement apparatus 200 is incorporated into a quantum computer 110 or other atomic system. In various embodiments, a quantum computer 110 or other atomic system further comprises a controller 30 configured to control various elements of the quantum computer 110 or other atomic system. For example, the controller 30 may be configured to control the voltage sources 50, a cryogenic system and/or vacuum system controlling the temperature and pressure within the cryogenic and/or vacuum chamber 40, manipulation sources 64 (e.g., 64A, 64B, 64C), magnetic field generators 70, active components of beam paths 66, and/or other systems controlling the environmental conditions (e.g., temperature, humidity, pressure, and/or the like) within the cryogenic and/or vacuum chamber 40, configured to manipulate and/or cause a controlled evolution of quantum states of one or more atomic objects confined by the confinement apparatus, and/or read and/or detect a quantum state of one or more atomic objects within the confinement apparatus.

As shown in FIG. 6, in various embodiments, the controller 30 may comprise various controller elements including processing device 605, memory 610, driver controller elements 615, a communication interface 620, analog-digital converter elements 625, and/or the like. For example, the processing device 605 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 605 of the controller 30 comprises a clock and/or is in communication with a clock.

For example, the memory 610 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 610 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 610 (e.g., by a processing device 605) causes the controller 30 to perform one or more steps, operations, processes, procedures and/or the like described herein for controlling one or more components of the quantum computer 110 or other atomic system (e.g., voltages sources 50, manipulation sources 64, magnetic field generators 70, and/or the like) to cause a controlled evolution of quantum states of one or more atomic objects, detect and/or read the quantum state of one or more atomic objects, and/or the like.

In various embodiments, the driver controller elements 615 may include one or more drivers and/or controller elements each configured to control one or more drivers. In various embodiments, the driver controller elements 615 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 605). In various embodiments, the driver controller elements 615 may enable the controller 30 to operate a manipulation source 64. In various embodiments, the drivers may be laser drivers; vacuum component drivers; drivers for controlling the flow of current and/or voltage applied to longitudinal, RF, and/or other electrodes used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the control electrodes 216 and/or RF electrodes 212 (e.g., including coupling signals). In various embodiments, the controller 30 comprises means for communicating and/or receiving signals from one or more detectors such as optical receiver components (e.g., cameras, MEMs cameras, CCD cameras, photodiodes, photomultiplier tubes, and/or the like). For example, the controller 30 may comprise one or more analog-digital converter elements 625 configured to receive signals from one or more detectors, optical receiver components, calibration sensors, photodetectors of an optics collection system 80, and/or the like.

In various embodiments, the controller 30 may comprise a communication interface 620 for interfacing and/or communicating with a computing entity 10. For example, the controller 30 may comprise a communication interface 620 for receiving executable instructions, command sets, and/or the like from the computing entity 10 and providing output received from the quantum computer 110 (e.g., from an optical collection system comprising one or more detectors 125) and/or the result of a processing the output to the computing entity 10. In various embodiments, the computing entity 10 and the controller 30 may communicate via a direct wired and/or wireless connection and/or one or more wired and/or wireless networks 20.

### Example Method of Performing a Cooling Operation Using Adiabatic Phonon Transfer

FIG. 7A provides a flowchart illustrating various processes, procedures, and/or the like performed by a controller 30 of a quantum computer 110 and/or atomic system for performing a cooling operation using adiabatic phonon transfer, in accordance with various embodiments. In various embodiments, the adiabatic phonon transfer is the transference of phonons between motional modes of an object crystal via adiabatic and/or coherent coupling of the motional modes between the phonons are transferred. In various embodiments, the adiabatic phonon transfer is a phonon rapid adiabatic passage. The example embodiment shown in FIG. 7A corresponds to the performance of a cooling operation on an object crystal 310 by a QCCD-based quantum computer, such as quantum computer 110.

Starting at step/operation 702, the controller 30 causes laser cooling of one or motional modes of an object crystal to be performed. For example, the controller 30 controls operation of one or more manipulation sources 64 to cause the manipulation source(s) 64 to generate and/or provide one or more manipulation signals. In various embodiments, the manipulation signals are configured to perform laser cooling of the object crystal. For example, the controller 30 controls operation of one or more manipulation sources 64 to cause the manipulation source(s) to generate and/or provide one or more laser cooling manipulation signals to a target location via respective beam path(s) 66.

The object crystal is located at the target location and the one or more manipulation signals being incident on the object crystal (e.g., at the target location) causes one or more first motional modes of the object crystal to be cooled. For example, the manipulation signals are incident on the object crystal (e.g., at the target location) causing the phonon population(s) of the one or more first motional modes to be reduced and/or depleted. For example, as a result of the manipulation signals interacting with the object crystal (e.g., at the target location) the phonon population of the one or more first motional modes may be approximately zero (e.g., substantially equal and/or close to zero) and/or below an appropriate threshold for the application.

In various embodiments, the controller 30 controls operation of one or more manipulation sources 64 via execution of executable instructions by the processing device 605 and/or driver controller elements 615 configured to control operation of the respective manipulation sources.

At step/operation 704, the controller 30 causes an adiabatic transfer of phonons from one or more second motional modes of the object crystal to one or more first motional modes of the object crystal. For example, the controller 30 controls operation of one or more voltage sources 50 to cause an adiabatic transfer of phonons and/or motional energy from one or more second motional modes to the one or more first motional modes. For example, in various embodiments, the controller 30 controls operation of one or more voltage sources 50 such that the environment experienced by the object crystal causes an adiabatic transfer of phonons from one or more second motional modes to one or more first motional modes of the object crystal. For example, the controller 30 controls operation of one or more voltage sources 50 such that the environment experienced by the object crystal causes an adiabatic transfer of phonons from one or more second motional modes to one or more first motional modes of the object crystal. In various embodiments, the adiabatic transfer of phonons takes less than 100 microseconds. In an example embodiment, the adiabatic transfer of phonons takes less than 20 microseconds.

For example, the controller 30 controls operation of one or more voltage sources 50 such that the one or more second motional modes and the one or more first motional modes of the object crystal are coupled such that the combined phonon populations of the first motional modes and the second motional modes are redistributed between the first motional mode(s) and the second motional mode(s). This results in the phonon population of the one or more first motional modes being increased and the phonon population of the one or more second motional modes being decreased. In various embodiments, the transfer of phonons from the one or more second motional modes to the one or more first motional modes is performed via phonon rapid adiabatic passage.

In various embodiments, the controller 30 controls operation of one or more voltage sources 50 via execution of executable instructions by the processing device 605 and/or driver controller elements 615 configured to control operation of the respective voltage sources.

At step/operation 706, the controller 30 causes laser cooling of one or more first motional modes of the object crystal. For example, the controller 30 controls operation of one or more manipulation sources 64 to cause the manipulation source(s) 64 to generate and/or provide one or more manipulation signals. In various embodiments, the manipulation signals are configured to perform laser cooling of the object crystal. For example, the controller 30 controls operation of one or more manipulation sources 64 to cause the manipulation source(s) to generate and/or provide one or more laser cooling manipulation signals to a target location via respective beam path(s) 66.

For example, the controller 30 controls operation of one or more manipulation sources 64 to cause a laser cooling of the one or more first motional modes of the object crystal. For example, the manipulation signals are incident on the object crystal (e.g., at the target location) causing the phonon population(s) of the one or more first motional modes to be reduced and/or depleted. For example, as a result of the manipulation signals interacting with the object crystal (e.g., at the target location) the phonon population of the one or more first motional modes may be approximately zero (e.g., substantially equal and/or close to zero) and/or below an appropriate threshold for the application.

In various embodiments, the controller 30 controls operation of one or more manipulation sources 64 via execution of executable instructions by the processing device 605 and/or driver controller elements 615 configured to control operation of the respective manipulation sources.

In various embodiments, steps/operations 704 and 706 may be repeated multiple times for various second motional modes and/or first motional modes. For example, steps/operations 704 and 706 may be repeated to reduce the respective phonon populations of one or more second motional modes of the object crystal by transferring phonons from the one or more second motional modes to one or more first motional modes and to reduce the respective phonon populations of one or more first motional modes by laser cooling the first motional modes. In various embodiments, steps/operations 704 and 706 are iterated and/or repeated until a desired and/or appropriate level of cooling is achieved, as appropriate for the application.

In various embodiments, performing the adiabatic transfer of phonons from the one or more second motional modes to the one or more first motional modes includes decreasing the object crystal length from an initial length d₀ to a final length d_{f}. In various embodiments, step/operation 702 is performed with the object crystal length substantially equal to the initial length d₀. In various embodiments, step/operation 706 is performed with the object crystal length substantially equal to the final length d_{f}. In various embodiments, the object crystal length is increased after performance of the adiabatic transfer of phonons and prior to the performance of step/operation 706. For example, in various embodiments, step/operation 706 is performed with the object crystal length substantially equal to the initial length d₀ and/or larger than the final length d_{f}.

In various embodiments, the one or more first motional modes are easier and/or faster to cool than the one or more second motional modes of the object crystal. For example, the one or more first motional modes of the object crystal have faster cooling rates (e.g., the motional energy in a first motional modes can be reduced more quickly than the motional energy in a second motional mode of the object crystal). In another example, a first motional mode of the object crystal is technically easier to cool (e.g., using lasers of wavelengths that are technically easier to generate or easier to guide from the laser/manipulation source to the target location) compared to a second motional mode of the object crystal.

FIG. 7B provides a flowchart illustrating various processes, procedures, and/or the like performed by a controller 30 of a quantum computer 110 and/or atomic system for performing an adiabatic phonon transfer via phonon rapid adiabatic passage, in accordance with various embodiments. For example, the processes, procedures, and/or the like illustrated in FIG. 7B are performed as part of step/operation 704, in various embodiments.

Starting at step/operation 712, the controller 30 causes the object crystal length to decrease. For example, the controller 30 controls operation of one or more voltage sources 50 to cause the voltage sources 50 to generate and provide (e.g., to respective control electrodes 216) voltage signals that cause the object crystal length to decrease. For example, as illustrated in FIG. 4 at an initial time t₀ of a phonon rapid adiabatic passage, the controller 30 controls operation of one or more voltage sources 50 to cause the voltage sources 50 to generate and provide voltage signals, that when applied to respective control electrodes 216, causes the confinement well within which the object crystal is confined, to reduce in size (at least in the direction defined by the longitudinal axis 205 at the target location). The reduction in size of the confinement well causes the atomic objects of the object crystal to be squeezed together such that the object crystal length d is reduced. The reduction in size of the confinement well also causes the confinement well frequency to increase.

In various embodiments, the controller 30 controls operation of one or more voltage sources 50 via execution of executable instructions by the processing device 605 and/or driver controller elements 615 configured to control operation of the respective voltage sources.

In various embodiments, as shown in FIG. 4, the controller 30 controls operation of the one or more voltage sources 50 such that the confinement well within which the object crystal is confined to continue to reduce in size (at least in the direction defined by the longitudinal axis 205 at the target location) during the performance of step/operation 714. For example, performance of step/operation 712 and step/operation 714 may overlap in time.

At step/operation 714, the controller 30 controls operation of one or more voltage sources 50 to cause the one or more voltage sources 50 to generate and provide a coupling signal that increases from zero to a maximum amplitude/voltage and then decreasing back to zero amplitude. Application of the coupling signal to an appropriate control electrode 216 causes the object crystal to experience a coupling force. For example, as illustrated in FIG. 4, starting at a first time t₁ while performing a phonon rapid adiabatic passage the controller 30 causes at least one voltage source 50 to generate and provide a coupling signal that, when applied to one or more control electrodes 216, generates the electric field that when the object crystal interacts therewith, causes the object crystal to experience the coupling force. For example, application of the coupling signal to the one or more control electrodes 216 causes the radial push, shim field, and/or higher order derivative terms of the potential to be generated. The amplitude of the coupling signal (e.g., a voltage signal) increases from zero amplitude to a maximum amplitude/voltage such that the coupling signal has the maximum amplitude/voltage at a second time t₂ of performing a phonon rapid adiabatic passage. In various embodiments, the controller 30 causes the at least one voltage source 50 to generate and provide the coupling signal such that, after the coupling signal reaches the maximum amplitude/voltage, the amplitude of the coupling signal decreases back to zero amplitude (e.g., at a third time t₃).

In various embodiments the rise and fall of the coupling signal is symmetric. For example, in an example embodiment, the time derivative of the coupling signal amplitude between the first time t₁ and the second time t₂ is the negative of the time derivative of the coupling signal amplitude between the second time t₂ and the third time t₃. For example, in an example embodiment, the amplitude of the coupling signal increases linearly with a slope of a between the first time t₁ and the second time t₂ and decreases linearly with a slope of −a between second time t₂ and the third time t₃

$$( e . g . , \frac{d ( coupling signal amplitude )}{dt} = \{ \begin{matrix}a & {t}_{1} \leq t \leq {t}_{2} \\ - a & {t}_{2} < t \leq {t}_{3}\end{matrix} , in an example embodiment ) .$$

In various embodiments, the amplitude of the coupling signal (and therefore the amplitude of the coupling force) increases slowly with respect to the motional mode frequencies of the first and second motional modes being coupled to one another. For example, in various embodiments, the time between the first time t₁ and the second time t₂ (e.g., t₂−t₁) is one to fifteen microseconds. For example, in various embodiments, the time between the second time t₂ and the third time t₃ (e.g., t₃−t₂) is one to fifteen microseconds. For example, in various embodiments, the time between the first time t₁ and the third time t₃ (e.g., t₃−t₁) is two to thirty microseconds.

With reference to FIG. 5, first time t₁ may correspond to the time when confinement well frequency is entering the transition window 530 from the left side. For example, the second time t₂ may correspond to approximately when the confinement well frequency pass through the degeneracy point 520. For example, the third time t₃ may correspond to when the confinement well frequency is exiting the transition window 530 via the right side of the transition window.

At step/operation 716, the controller 30 causes the object crystal length to stop decreasing. For example, the controller 30 controls operation of one or more voltage sources 50 to cause the voltage sources 50 to generate and provide (e.g., to respective control electrodes 216) voltage signals that cause the object crystal length to stop decreasing. For example, as illustrated in FIG. 4 at a final time t_{f} of a phonon rapid adiabatic passage, the object crystal length reaches a final object crystal length d_{f} and the controller 30 controls operation of one or more voltage sources 50 to cause the voltage sources 50 to generate and provide voltage signals, that when applied to respective control electrodes 216, causes the confinement well within which the object crystal is confined, to stop reducing in size (at least in the direction defined by the longitudinal axis 205 at the target location). For example, the controller 30 controls operation of one or more voltage sources 50 to cause the voltage sources 50 to generate and provide voltage signals, that when applied to respective control electrodes 216, causes the confinement well within which the object crystal is confined, to maintain a same size (at least in the direction defined by the longitudinal axis 205 at the target location). The size of the confinement well maintaining its size causes the object crystal length d to be steady and/or to maintain its value. For example, at a final time t_{f} of performing a phonon rapid adiabatic passage, the controller 30 controls operation of the voltage sources 50 such that the voltage sources generate and provide voltage signals that cause the object crystal length to stop decreasing and/or be maintained at the final length d_{f}.

In various embodiments, the controller 30 controls operation of one or more voltage sources 50 via execution of executable instructions by the processing device 605 and/or driver controller elements 615 configured to control operation of the respective voltage sources.

At step/operation 718, the controller 30 causes the object crystal length to increase. For example, the controller 30 controls operation of one or more voltage sources 50 to cause the voltage sources 50 to generate and provide (e.g., to respective control electrodes 216) voltage signals that cause the object crystal length to increase. In various embodiments, the object crystal length may be increase to a length that is greater than final length d_{f} and less than the initial length d₀. In various embodiments, the object crystal length is increased to be substantially equal to the initial length d₀. In various embodiments, the object crystal length is increased to be greater than the initial length d₀. For example, the controller 30 controls operation of one or more voltage sources 50 to cause the voltage sources 50 to generate and provide voltage signals, that when applied to respective control electrodes 216, causes the confinement well within which the object crystal is confined, to increase in size (at least in the direction defined by the longitudinal axis 205 at the target location). The size of the confinement well increasing (at least in the direction defined by the longitudinal axis 205 at the target location) causes the object crystal length d to increase (in the direction defined by the longitudinal axis 205 at the target location).

In various embodiments, the controller 30 controls operation of one or more voltage sources 50 via execution of executable instructions by the processing device 605 and/or driver controller elements 615 configured to control operation of the respective voltage sources.

### Technical Advantages

Various embodiments provide technical solutions to technical problems of laser cooling atomic objects within a confinement apparatus. For example, when cooling atomic objects, each motional mode needs to be cooled independently and the cooling rates of different motional modes may be very different. For example, the cooling rate between two different motional modes of an object crystal may differ by more than an order of magnitude. However, the total cooling time for the object crystal can be limited by the slowest cooling rate of all the motional modes. This results in a significant amount of run time of various atomic systems and/or quantum computers being dedicated to cooling operations rather than quantum state evolution operations. Additionally, laser cooling some of the motional modes may require the use of laser beams characterized by wavelengths that are technically difficult to generate and/or difficult to guide from the laser or other manipulation source to the target location defined at least in part by the confinement apparatus. Therefore, technical problems exist regarding laser cooling object crystals.

Various embodiments provide technical solutions to these technical problems. For example, various embodiments cause motional energy (e.g., phonons) to be adiabatically passed from one or more motional modes of the object crystal that are harder and/or slower to cool to one or more motional modes of the object crystal that are easier and/or faster to cool (e.g., via laser cooling). For example, one or more performances of a phonon rapid adiabatic passage may be used to reduce the phonon population of one or more motional modes of the object crystal that are harder and/or slower to cool and correspondingly increase the phonon population of one or more motional modes of the object crystal that are easier and/or faster to cool. The one or more motional modes of the object crystal that are easier and/or faster to cool may then be efficiently cooled via laser cooling. The transfer of energy (phonons) from the harder and/or slower to cool motional modes of the object crystal to the easier and/or faster to cool motional modes of the object crystal enables cooling of the object crystal at a faster cooling rate than conventional laser cooling. As such, the effective cooling rate of the object crystal may be improved, and the object crystal may be cooled relatively efficiently.

Thus, various embodiments provide technical improvements to the fields of quantum computer operation (e.g., for a QCCD-based quantum computer and/or the like) and/or laser cooling of confined atomic objects and/or object crystals. For example, by reducing the effective cooling time of an atomic object and/or object crystal through the adiabatic transfer of phonons from the slower to cool motional mode(s) to the faster to cool motional mode(s), provides for faster quantum circuit run times and enables deeper quantum circuits to be performed (e.g., within the qubit coherence time constraints).

### Example Computing Entity

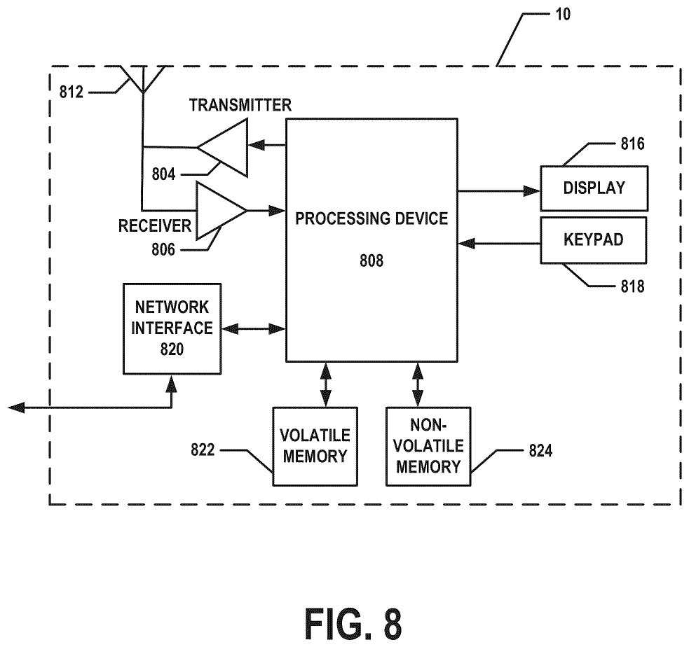

FIG. 8 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 8, a computing entity 10 can include an antenna 812, a transmitter 804 (e.g., radio), a receiver 806 (e.g., radio), and a processing device 808 that provides signals to and receives signals from the transmitter 804 and receiver 806, respectively. The signals provided to and received from the transmitter 804 and the receiver 806, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 comprises a network interface 820 configured to communicate via one or more wired and/or wireless networks 20.

In various embodiments, the processing device 808 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products.

The computing entity 10 may also comprise a user interface device comprising one or more user input/output interfaces (e.g., a display 816 and/or speaker/speaker driver coupled to a processing device 808 and a touch screen, keyboard, mouse, and/or microphone coupled to a processing device 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for cooling an object crystal comprising at least two atomic objects and confined by a confinement apparatus, the method comprising:
controlling one or more voltage sources to cause an object crystal length to decrease, the object crystal length measured in a direction parallel to a radio frequency (RF) null axis defined by the confinement apparatus at a location of the object crystal; and
controlling the one or more voltage sources to cause the object crystal to experience a coupling force that increases to a maximum amplitude and then decreases from the maximum amplitude to a zero amplitude, wherein the coupling force contains at least a component in a direction that is radial to the RF null axis,
wherein while the object crystal is experiencing a non-zero coupling force, the decrease in the object crystal length causes a first motional mode of the object crystal to be degenerate with a second motional mode of the object crystal such that phonons are adiabatically transferred between the first motional mode and the second motional mode.

2. The method of claim 1, further comprising, prior to controlling the one or more voltage sources to cause the object crystal length to decrease and the object crystal to experience the coupling force, controlling one or more manipulation sources to perform laser cooling of the first motional mode of the object crystal.

3. The method of claim 1, further comprising, controlling one or more manipulation sources to performing laser cooling of the first motional mode of the object crystal after the coupling force decreases to the zero amplitude.

4. The method of claim 3, further comprising, after the coupling force decreases to the zero amplitude and prior to controlling the one or more manipulation sources to performing laser cooling of the first motional mode of the object crystal, controlling the one or more voltage sources to cause at least one of (a) the object crystal length to stop decreasing in size such that the object crystal length is maintained at a final length or (b) the object crystal length to increase to a length that is longer than the final length.

5. The method of claim 3, wherein the one or more voltage sources and the one or more manipulation sources are controlled to iteratively perform (a) adiabatically transferring phonons between the first motional mode and the second motional mode and (b) laser cooling the first motional mode.

6. The method of claim 1, wherein the phonons are adiabatically transferred between the first motional mode and the second motional mode by transferring one or more phonons from the second motional mode to an intermediate motional mode and transferring one or more phonons from the intermediate motional mode to the first motional mode.

7. The method of claim 1, wherein the at least two atomic objects comprise a first atomic object of a first atomic object type and a second atomic object of a second atomic object type, where the first atomic object type is different from the second atomic object type.

8. The method of claim 1, wherein the coupling force increases to the maximum amplitude over a first length of time, the coupling force decreases from the maximum amplitude to the zero amplitude over a second length of time, and the first length of time and the second length of time are longer than a reciprocal of a difference between a motional mode frequency of the first motional mode and a motional mode of the second motional mode.

9. The method of claim 1, wherein the coupling force is one (a) a radial push, (b) a torque caused by a shim field in a plane parallel to a plane defined by the confinement apparatus, or (c) a higher order (third, fourth, etc.) derivative term in a potential generated by the confinement apparatus at the location of the object crystal.

10. A method for laser cooling an object crystal comprising at least two atomic objects and confined by a confinement apparatus, the method comprising:
controlling one or more manipulation sources to cause a first instance of one or more manipulation signals to be incident on a target location defined at least in part by the confinement apparatus, the first instance of the one or more manipulation signals configured to laser cool a first motional mode of the object crystal, and the confinement apparatus operating to confine the object crystal at the target location;
causing an adiabatic transfer of phonons from a second motional mode of the object crystal to the first motional mode of the object crystal; and
controlling the one or more manipulation sources to cause a second instance of the one or more manipulation signals to be incident on the target location, the second instance of the one or more manipulation signals configured to laser cool the first motional mode of the object crystal.

11. The method of claim 10, wherein the adiabatic transfer of phonons from the second motional mode to the first motional mode is performed via phonon rapid adiabatic passage.

12. The method of claim 11, wherein performing the phonon rapid adiabatic passage comprises:
controlling one or more voltage sources to cause an object crystal length of the object crystal to decrease; and
controlling the one or more voltage sources to cause the object crystal to experience a coupling force that increases to a maximum amplitude and then decreases from the maximum amplitude to a zero amplitude,
wherein while the object crystal is experiencing a non-zero coupling force, the decrease in the object crystal length causes the first motional mode of the object crystal to be degenerate with the second motional mode of the object crystal such that phonons are adiabatically transferred between the first motional mode and the second motional mode.

13. The method of claim 12, further comprising, after the coupling force decreases to the zero amplitude and prior to controlling the one or more manipulation sources to cause the second instance of the one or more manipulation signals to be incident on the target location, controlling the one or more voltage sources to cause at least one of (a) the object crystal length to stop decreasing in size such that the object crystal length is maintained at a final length or (b) the object crystal length to increase to a length that is longer than the final length.

14. The method of claim 12, wherein the one or more voltage sources and the one or more manipulation sources are controlled to iteratively perform (a) adiabatically transferring phonons between the first motional mode and the second motional mode and (b) laser cooling the first motional mode.

15. The method of claim 12, wherein the coupling force increases to the maximum amplitude over a first length of time, the coupling force decreases from the maximum amplitude to the zero amplitude over a second length of time, and the first length of time and the second length of time are longer than a reciprocal of a difference between a motional mode frequency of the first motional mode and the motional mode frequency of the second motional mode.

16. The method of claim 10, wherein the phonons are adiabatically transferred between the first motional mode and the second motional mode by transferring one or more phonons from the second motional mode to an intermediate motional mode and transferring one or more phonons from the intermediate motional mode to the first motional mode.

17. The method of claim 10, wherein the at least two atomic objects comprise a first atomic object of a first atomic object type and a second atomic object of a second atomic object type, where the first atomic object type is different from the second atomic object type.

18. The method of claim 10, wherein the adiabatic transfer of phonons takes less than 100 microseconds.

19. A system comprising:
a confinement apparatus configured to confine an object crystal comprising at least two atomic objects and defining, at least in part, a target location;
one or more manipulation sources configured to generate and provide one or more manipulation signals; and
a controller configured to control operation of the confinement apparatus and the one or more manipulation sources to cause the system to perform at least:
causing the confinement apparatus to confine the object crystal at the target location;
causing a first instance of the one or more manipulation signals to be incident on the target location, the first instance of the one or more manipulation signals configured to laser cool a first motional mode of the object crystal;
causing an adiabatic transfer of phonons from a second motional mode of the object crystal to the first motional mode of the object crystal; and
causing a second instance of the one or more manipulation signals to be incident on the target location, the second instance of the one or more manipulation signals configured to laser cool the first motional mode of the object crystal.

20. The system of claim 19, further comprising one or more voltage sources operatively coupled to respective electrodes of the confinement apparatus, wherein the controller is configured to control operation of the one or more voltage sources to cause the system to perform at least:
voltage signals to be provided to the respective electrodes that cause an object crystal length of the object crystal to decrease; and
a coupling signal to be provided to at least one of the respective electrodes to cause the object crystal to experience a coupling force that increases to a maximum amplitude and then decreases from the maximum amplitude to a zero amplitude,
wherein while the object crystal is experiencing a non-zero coupling force, the decrease in the object crystal length causes the first motional mode of the object crystal to be degenerate with the second motional mode of the object crystal such that phonons are adiabatically transferred between the first motional mode and the second motional mode.

21. The system of claim 19, wherein the system is a quantum computer, at least one of the at least two atomic objects of the object crystal is used as a qubit of the quantum computer, and at least another of the at least two atomic objects of the object crystal is used for sympathetically cooling the qubit.
